(19) United States
(12) Patent Application Publication
(10) Pub. No.: US 2006/0113712 A1
(43) Pub. Date: Jun. 1, 2006

(54) Plastic paint container with non-stick interior surfaces

(76) Inventors: Francis T. Azzarello, Woodstock, IL (US); John W. Bixby, Lombard, IL (US); Timothy Moczulewski, Kenosha, DE (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/998,925

(22) Filed: Nov. 29, 2004

(51) Int. Cl. B29C 69/00

(52) U.S. Cl. 264/446; 264/483; 264/232

(57) ABSTRACT

A method for promoting adhesion of a “skin” forming on the surface of a paint stored in a plastic paint container (10) to walls of the container first includes molding a can (12), plug (14), and ring (16) comprising the container to have their interior surfaces as textured, non-smooth surfaces. Next, the interior surfaces of the can, plug, and ring are subjected to an energy treatment after these parts are removed from their molds. This is done to produce an energy change in these surfaces. Third, an adhesion promoting material is applied to the energy treated interior surfaces of the container. This adhesion promoting material, which is preferably a chlorinated polyolefin, promotes adhesion of the skin to these interior surfaces as the skin forms. The material is applied within a predetermined period after the parts are energy treated.

### CROSS REFERENCE TO RELATED APPLICATIONS

None

### STATEMENT REGARDING FEDERALLY SPONSORED RESEARCH OR DEVELOPMENT

N/A

### BACKGROUND OF THE INVENTION

This invention relates to plastic containers such as pails for holding paint and other liquids on which a film or “skin” may form; and, more particularly, to a surface treatment for interior surfaces of the container to attract a skin formed on the surface of the liquid and to prevent the skin from detaching and breaking up into clumps in the liquid (paint) stored in the container.

Plastic containers are gaining in popularity. Among the reasons for this is that they do not rust, nor are they easily dented during use. Further, plastic containers are readily made in a wide variety of sizes and shapes. The majority of plastic containers are used to hold and store liquids, one type of which includes paints.

Paint is formulated to be applied wet to a surface and then dry once it has been applied. However, some paint tends to dry prior to its application, while still in an un-opened container. This drying is commonly referred to as “skinning”. Tests have shown that skin formation occurs under a variety of circumstances, sometimes even when paint is stored in a hermetically sealed glass jar. While skin formation occurs over time, it has been found to be accelerated by high temperatures; and in some paint formulations, particularly those having low VOCs (volatile organic compounds), the skin forms quicker than for paint formulations having higher VOCs.

If a skin forms in a container prior to opening, it is not necessarily bad. This is because if the “skin” has not fully formed, it can be dissolved or dispersed back into the paint by shaking or stirring the container and its contents. Skin becomes a problem when a fully formed skin does not adhere to the interior surfaces of its container, but instead settles into or on top of the paint stored in the container. This condition manifests itself in one of two ways: first, a sheet or thin layer of skin settles on the top of the liquid; or second, pieces of skin settle down into the paint.

Paint can shakers which mix a color concentrate into a base color (white) in a paint can will cause skin that has not sufficiently adhered to the inside surfaces of the container surfaces to fall into the paint. If an article or surface is now painted using paint from the can, clumps or chunks of paint may be carried by the brush or applicator onto these surfaces and result in a clumpy rather than smooth surface appearance. If a spraying attachment is attached to the paint can, any skin clumps can clog the spraying head of the attachment, requiring that the attachment then be taken part and cleaned.

When paint has been stored in metal cans, skin adhesion has not been a major problem. This is because the skin tends to adhere to metal or “tinplate” from which the paint can is made. For water borne paint formulations, the tinplate has an internal coating or “lining” which serves as a barrier to the metal substrate of the container and keeps the paint can from rusting. Depending on the paint formulation and the type of container lining, skin adhesion may be a problem. However, in general, the problem has been managed, and fillers of paint containers have accepted a slight occurrence of detached skin in the metal cans they fill as a matter of course.

Now, with plastic containers increasingly replacing metal ones, primarily to reduce dents and eliminate rusting, skinning has become a problem. This is due to quicker moisture permeation thru the plastic versus metal containers and because the plastic compounds used for forming paint pails and paint cans are chemically inert. Thus, there is no chemical attraction between the paint and the container and therefore no adhesion of skinned paint to inner surfaces of a plastic container. Fillers of paint cans have found that “floating” a small amount of ethylene glycol on top of the paint will delay the formation of skin; but, lack of adhesion still creates a significant problem and this float material is not an acceptable constituent of low V.O.C. paints.

To promote skin adhesion, covers used on the larger pails are typically flame treated. However, over a relatively brief period of time after flame treatment (a few weeks to possibly two months), the energy of the treated surface returns to its original state and any advantage in promoting adhesion is lost. Paradoxically, this undoing of the energy treatment benefits occurs about the time a skin usually starts to form. Accordingly, it is questionable as whether or not energy treatment alone serves a useful purpose.

### BRIEF SUMMARY OF THE INVENTION

The present invention, briefly stated, is directed to a method for promoting adherence of paint “skin” to a surface of a plastic paint container so the skin does not break up into clumps in the paint and be transferred by a paint brush or the like to a surface being painted. The container includes a can, a plug for covering an open mouth end of the can, and a ring secured adjacent the open mouth end of the can and providing means of attachment for the cover. The method first includes molding the can, plug, and ring so they have interior surfaces which are textured, non-smooth surfaces. Next, the interior surfaces of the can, plug, and ring are subjected to a flame treatment after these parts are removed from their molds. This is done to produce a surface energy change of these surfaces. Third, an adhesion promoting material is added to the interior surface of the can, ring, and plug after the energy treatment. This chemical change treatment acts as an adhesion promoting material, which is preferably a chlorinated polyolefin, and causes the paint to adhere to these surfaces. Also preferably, this material is applied within two days after the parts are flame treated so to benefit from the method of the invention as it is implemented. Alternatively, the same invention can be applied to a 2 piece plastic container having a body and cover such as a pail.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is an exploded view of a plastic container;

FIG. 2 is a plan view of a paint can and a plug or lid for the can;

FIG. 3 is a simplified representation of an assembly line for treating components of a plastic can to prevent product adhesion; and.

FIGS. 4 and 5 are elevation and plan views of portions of molds used to make components of the container with textured interior surfaces in accordance with the present invention.

Corresponding reference characters indicate corresponding parts throughout the several views of the drawings.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

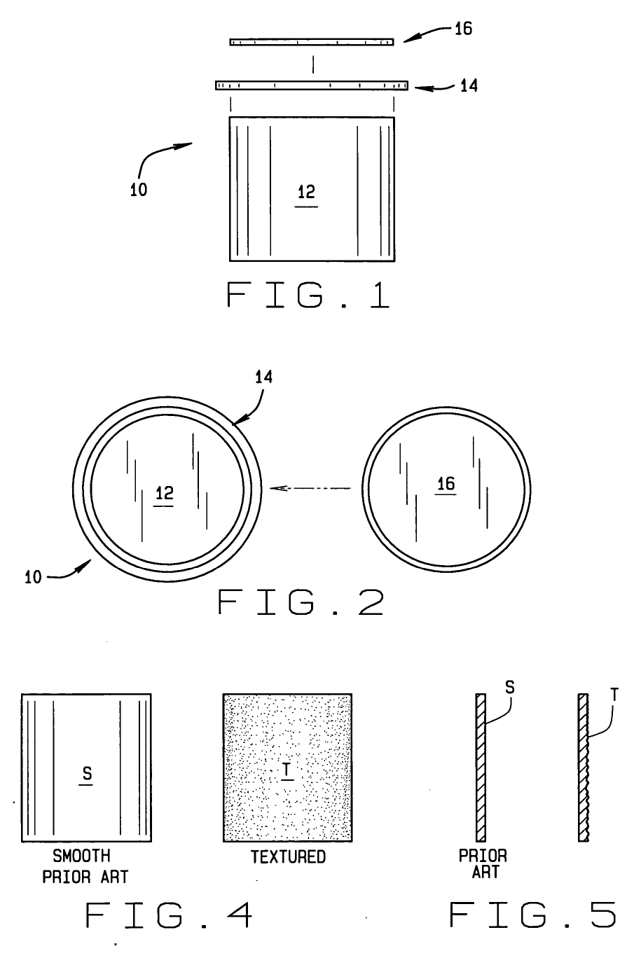

Referring to the drawings, a plastic container such as a paint can or the like is indicated generally 10 in FIGS. 1 and 2. The paint can is comprised of three separate components each of which is of a molded plastic material. First is an open mouthed can 12 whose size varies depending upon the quantity of paint the container is to hold. A typical container size is one gallon; although, the size may range from one quart up to five gallons. Next is a ring 14 which fits about the open mouth end of the can and is attached to the can by spin welding or the like. The container need not have a separate ring. Finally is a plug or cover 16 which fits over the open end of can 12 and engages ring 14 to close the container. The design and construction of container 10 is described, for example, in U.S. Pat. No. 6,491,185 which is assigned to the same assignee as the present application.

As discussed above, when the container is filled with paint, over time, a skin forms on the interior surfaces of the container within the vapor phase. A problem arises when this skin is allowed to detach from the interior surfaces. To prevent this problem, it is desirable for the skin, once formed, to cling to interior surfaces of the paint container. To achieve this adherence, the present invention is directed to three improvements each of which contributes to causing the paint skin to cling to the container and not break up in the paint.

The first improvement is to modify the molds in which the can, ring, and plug are formed so that rather than the resulting component being produced with a smooth paint contact surface, the surface rather has a textured finish. Referring to FIGS. 4 and 5, current paint can construction, i.e., those paint can segments labeled PRIOR ART in FIGS. 4 and 5, have a smooth surface such as the surface indicated S. With the improvement of the present invention, the molds by which these components are made are modified so the paint contact surfaces on each of the can, ring, and plug now have a textured surface finish T. The resulting surface irregularities created by texturing these surface finishes now allows the paint to adhere to them, so as a skin forms, it is easier for it to cling to these surfaces rather than separate and form clumps.

Next, in addition to forming the inside surfaces of the can, ring, and plug as textured surfaces, the method includes treating the respective interior surfaces of these components to produce a an energy change in the surface to improve bonding of paint skin or the third step chemical treatment. This energy treatment can be performed in a number of ways to achieve the desired results. One such way is to direct a flame at each surface after the particular components are removed from their respective molds. Another way is to expose these surfaces to a corona discharge, again after the parts are removed from the molds. A third energy treatment procedure uses a gas plasma.

A third step, the chemical treatment, in the method is to coat the interior surfaces of the can, ring, and plug with a fluid material that further promotes paint skin adherence to the surfaces. This is accomplished by applying a solution to the surfaces after their energy treatment. The material used for this purpose is preferably a chlorinated polyolefin; although the material can be selected from a group of materials which includes liquid chlorinated polyolefin, halogenated, carboxyl modified, hydroxyl modified, or oxidized materials. While an application of one coat of the solution may be sufficient, those skilled in the art will understand that a plurality of coats can be applied, or that the surfaces of the can, for example, may receive multiple coats; while the inner surface of the plug may receive only a single coat.

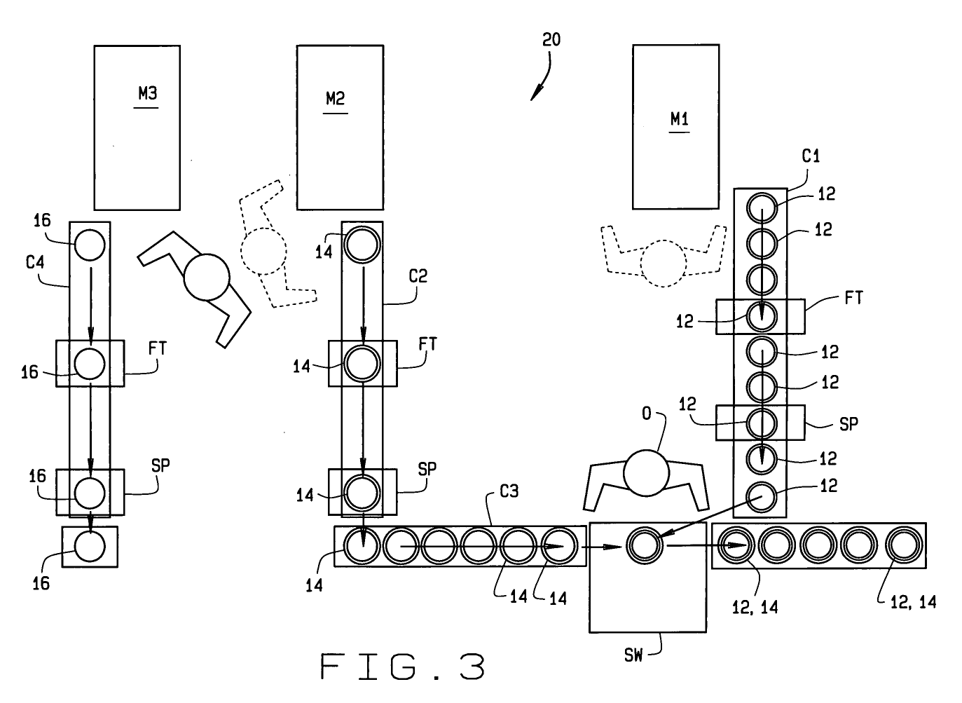

Referring to FIG. 3, a paint can manufacturing and assembly line 20 is shown in which the method of the present invention is implemented. As indicated in the Fig., cans 12, rings 14, and plugs 16 are separately packaged and transported from their molding sites to the line as indicated at M1, M2, and M3 respectively. As discussed above, the cans, rings, and plugs are each molded so their inner surfaces with which paint comes into contact are textured rather than smooth surfaces.

The cans are unloaded from their container and placed upon a conveyor C1. As the cans move along the conveyor, they pass through an energy treating installation FT where they are subjected to a flame treatment, a corona discharge, or a gas plasma environment which produces the desired energy change to the inner can surface. From the energy treatment station, the cans continue along the conveyor to a spray station SP. As the cans pass through this installation, a chlorinated polyolefin (or other preferred material) is sprayed into the interior of the can.

Simultaneously with the cans 12, rings 14 are unloaded from their container and placed on a conveyor C2. The rings are now similarly energy treated and sprayed as they pass along the conveyor. At the end of conveyor C2, the rings 14 are transferred to another conveyor C3. This conveyor moves the rings toward the end of conveyor C1 where the cans 12 are located. Now, an operator O takes a can 12 and ring 14, connects them together and places them in an assembly machine which could be a spin or sonic welder or gluing type unit SW. In this unit, the rings are permanently attached to the cans. The completed assembly is removed from the assembler unit and packaged for shipment to a filler who fills the cans with a paint.

At the same time the cans and rings are being treated and assembled together, the plugs 16 are deposited on a conveyor C4 and also energy treated and sprayed. After these treatments, they are also forwarded to the filler for closing the paint cans after they have been filled with paint. After the cans are filled, the plugs are put in place and the filled, closed containers can be inventoried, or set sent to a retail outlet for sale to the consumer. Regardless of whether the container sits on a shelf for a while, or is sold and the contents used relatively soon after filling, the method of the invention insures that if a skin does form on the interior surface of the container, the skin will adhere to these surfaces of the paint can, or the cover, and not break up into clumps.

In view of the above, it will be seen that the several objects and advantages of the present invention have been achieved and other advantageous results have been obtained.

Having thus described the invention, what is claimed and desired to be secured by Letters Patent is:

1. A method for manufacturing a plastic container to promote adherence of a “skin” which forms on the surface of a fluid material stored in a container so to prevent the skin from breaking up when the contents of the container are to be used comprising:
texturing the interior surfaces so that the surfaces are not smooth; and,
treating the interior surfaces of the container to produce an energy change in the surface.

2. The method of claim 1 further including applying a material to the interior surfaces of the container so the skin will adhere to these surfaces.

3. The method of claim 1 in which the container includes a can, a plug for covering an open mouth end of the can, and a ring secured adjacent the open mouth end of the can to provide a means of attachment for the cover, and the method includes:
texturing the interior surfaces of each of the can, plug, and ring so these surfaces are not smooth; and,
treating the interior surfaces of each of the can, plug, and ring to produce an energy change in each of these surfaces.

4. The method of claim 3 in which texturing the interior surfaces of each of the can, plug, and ring includes texturing surfaces of respective molds in which the can, plug, and ring are formed so these parts have textured surfaces when formed in the molds.

5. The method of claim 3 in which energy treating the interior surfaces of each of the can, plug, and ring to produce an energy change in each of these surfaces includes flame treating these surfaces after the parts are removed from their respective molds.

6. The method of claim 3 in which energy treating the interior surfaces of each of the can, plug, and ring to produce an energy change in each of these surfaces includes subjecting these surfaces to a corona discharge after the parts are removed from their respective molds.

7. The method of claim 3 in which energy treating the interior surfaces of each of the can, plug, and ring to produce an energy change in each of these surfaces includes subjecting these surfaces to a gas plasma after the parts are removed from their respective molds.

8. The method of claim 2 further applying the material after the energy treatment.

9. The method of claim 2 in which the material is a chlorinated polyolefin.

10. The method of claim 2 in which the material is selected from one of a group of materials which includes liquid chlorinated polyolefin, halogenated, carboxyl modified, hydroxyl modified, or oxidized materials.

11. The method of claim 8 further including applying the material within a predetermined interval after the energy treatment is applied to the interior surfaces.

12. The method of claim 11 in which the interval is approximately two days.

13. A method for promoting adherence of a “skin” formed on the surface of paint stored in a plastic paint container to the container comprising:
texturing interior surfaces of the paint container so the surfaces are not smooth;
energy treating the interior surfaces of the container to produce an energy change in the surface; and,
applying a material to the interior surfaces of the container so the paint will adhere thereto.

14. The method of claim 13 in which the container includes a can, a plug for covering an open mouth end of the can, and a ring secured adjacent the open mouth end of the can to provide a means of attachment for the cover, and the method includes:
texturing the interior surfaces of each of the can, plug, and ring so these surfaces are not smooth; and,
energy treating the interior surfaces of each of the can, plug, and ring to produce an energy change in each of these surfaces.

15. The method of claim 14 in which texturing the interior surfaces of each of the can, plug, and ring includes texturing surfaces of respective molds in which the can, plug, and ring are formed so these parts have textured surfaces when formed in the molds.

16. The method of claim 14 in which treating the interior surfaces of each of the can, plug, and ring to produce an energy change in each of these surfaces includes flame treating these surfaces after the parts are removed from their respective molds.

17. The method of claim 14 in which treating the interior surfaces of each of the can, plug, and ring to produce an energy change in each of these surfaces includes subjecting these surfaces to a corona discharge after the parts are removed from their respective molds.

18. The method of claim 14 in which treating the interior surfaces of each of the can, plug, and ring to produce an energy change in each of these surfaces includes subjecting these surfaces to a gas plasma after the parts are removed from their respective molds.

19. The method of claim 13 further including applying the material within a predetermined period of time after the energy treatment is applied to the interior surfaces of the container.

20. The method of claim 19 in which the predetermined period of time is approximately two days.

21. The method of claim 13 in which the material is a chlorinated polyolefin.

22. The method of claim 13 in which the material is selected from one of a group of materials which includes liquid chlorinated polyolefin, halogenated, carboxyl modified, hydroxyl modified, or oxidized materials.

23. A method for promoting adherence of a “skin” forming on the surface of paint stored in a plastic paint container to a wall of the container, the container being comprised of a can, a plug for covering an open mouth end of the can, and a ring secured adjacent the open mouth end of the can to provide a means of attachment for the cover, and the method comprising:
molding the can, plug, and ring to have interior surfaces which are textured, non-smooth surfaces;
subjecting the interior surfaces of the can, plug, and ring to a flame treatment after these parts are removed from their molds so to produce a chemical change in these surfaces; and,
applying a material to the interior surfaces of the container to promote adhesion of the skin to these surfaces.

24. The method of claim 23 in which the material is a chlorinated polyolefin.

25. The method of claim 23 in which the adhesion promoting material is selected from one of a group of materials which includes liquid chlorinated polyolefin, halogenated, carboxyl modified, hydroxyl modified, or oxidized materials.

26. The method of claim 23 further including applying the material within a predetermined period of time after the energy treatment is applied to the interior surfaces of the container.

27. The method of claim 26 in which the predetermined period of time is approximately two days.
